(19) United States
(12) Patent Application Publication
(10) Pub. No.: US 2024/0354851 A1
(43) Pub. Date: Oct. 24, 2024

(54) BLOCKCHAIN AND IMAGING BASED CARBON DIOXIDE TRANSACTION SYSTEM AND METHOD

(71) Applicant: GREENEMISSIONS 44 AB, Höganäs (SE)

(72) Inventors: Patrik Stolt, Arild (SE); Filipe Pohlmann Gonzaga, Geneva (CH)

(21) Appl. No.: 18/685,091

(22) PCT Filed: Nov. 10, 2022
(86) PCT No.: PCT/EP2022/081458

§ 371 Date: Feb. 20, 2024

(30) Foreign Application Priority Data
Nov. 10, 2021 (EP) 21207593.1

(51) Int. Cl. G06Q 40/04; G06V 20/13

(52) U.S. Cl. CPC G06Q 40/04; G06V 20/13; G06Q 2220/00

(57) ABSTRACT

A computer-implemented method for processing carbon dioxide related transactions includes the steps of: providing a distributed blockchain ledger; storing at least a portion of the distributed blockchain ledger on a plurality of computing devices; adding a transaction of carbon dioxide to the distributed blockchain ledger, wherein the transaction comprises a carbon dioxide token assigned to a carbon dioxide sequestration associated with a geographic area; obtaining at least a first image of the geographic area before the sequestration; obtaining at least a second image of the geographic area after the sequestration; determining, based on the first image and second image whether the carbon dioxide sequestration has been effectuated; and in case the carbon dioxide sequestration has been effectuated, automatically triggering a payment for the carbon dioxide token and updating the transaction of carbon dioxide in the distributed blockchain ledger on the plurality of computing devices.

### CROSS-REFERENCE TO RELATED APPLICATIONS

This application is the U.S. National Stage of PCT/EP2022/081458 filed on Nov. 10, 2022, which claims priority to European Patent Application 21207593.1 filed on Nov. 10, 2021, the entire content of both are incorporated herein by reference in their entirety.

### FIELD OF THE INVENTION

The present disclosure relates to a method and a system for processing carbon dioxide related transactions. The system makes use of a combination of blockchain and imaging technologies, such as satellite imaging, to disrupt existing systems.

### BACKGROUND OF THE INVENTION

Carbon dioxide (CO2) is a gas that occurs naturally in the atmosphere. The greenhouse effect is referred to as the process by which radiation from a planet's atmosphere warms the planet's surface to a temperature above what it would be without this atmosphere. CO2 is produced by fossil fuel burning and other activities, such as energy industry and cement production. CO2 emission is thus, generally, considered to cause a negative global environmental impact. A carbon dioxide equivalent or CO₂ equivalent (CO₂-eq) is a metric measure used to compare the emissions from various greenhouse gases on the basis of their global-warming potential (GWP) by converting amounts of other gases to the equivalent amount of carbon dioxide with the same global warming potential.

Measures for counteracting increased levels of CO2 in the atmosphere include both reducing emissions and removing existing CO2. Photosynthesis is a process that removes CO2 naturally and generates Oxygen (O2) and binds carbon (C) in plant biomass. Generally, CO2 removal is a process in which CO2 is removed from the atmosphere and sequestered for long periods of time. Carbon dioxide removal methods include afforestation, agricultural practices that sequester carbon (C) via biomass bound C in soils, bio-energy with carbon capture and storage, ocean fertilization, enhanced weathering, and direct air capture when combined with storage.

In order to tackle increased levels of CO2 in the atmosphere, CO2 emission trading systems (Carbon credits) and markets have been introduced. Emissions trading works by setting a quantitative total limit on the emissions produced by all participating emitters. As a result, the price automatically adjusts to this target.

A similar type of system is based on CO2 credits, in which, for example, farmers can get paid to sequester carbon in the soil. The sale of carbon credits presents an opportunity for farmers to receive financial benefits from changing to more environmentally beneficial agricultural practices or use otherwise unused land to sequester carbon. Carbon credits can be said to quantify carbon sequestration. A carbon credit is a tradeable certificate.

While carbon credit trading has a great potential of encouraging carbon sequestration, there are, however, also technical challenges associated with the existing systems for CO2 trading. These challenges relate to, inter alia, quality control, traceability, transaction validation, verification and integration of such features in a secure system.

### SUMMARY OF THE INVENTION

The present disclosure relates to a method and a system that overcome some of the technical challenges and issues related to carbon dioxide trading systems. More specifically, the disclosure relates to a method and a system for processing carbon dioxide related transactions by earth observation biomass calculations. The system makes use of a combination of blockchain and imaging technologies, providing transparency and traceability among stakeholders.

A first embodiment of the presently disclosed computer-implemented method for processing carbon dioxide or carbon dioxide equivalent related transactions, comprises the steps of:
providing a distributed blockchain ledger;
storing at least a portion of the distributed blockchain ledger on a plurality of computing devices;
adding a transaction of carbon dioxide to the distributed blockchain ledger, wherein the transaction comprises a carbon dioxide token assigned to a carbon dioxide sequestration associated with a geographic area;
obtaining at least a first image, such as a first satellite image, of the geographic area before the sequestration;
obtaining at least a second image, such as a second satellite image, of the geographic area after the sequestration;
determining, based on the first image and second image whether the carbon dioxide sequestration has been effectuated; and
in case the carbon dioxide sequestration has been effectuated, automatically triggering a payment for the carbon dioxide token and updating the transaction of carbon dioxide in the distributed blockchain ledger on the plurality of computing devices.

The method may comprise a smart contract transaction between a producer and a buyer, wherein a transaction for a CO2 binding activity through earth observation is executed. The method may comprise the step of measuring, calculating or estimating the producer's original biomass quantity to determine a neutral state or starting point. Preferably, this neutral state or starting point corresponds to a point in time when the first image is captured.

### Definitions

“Carbon dioxide”, or “CO2”, within the context of the present disclosure shall, be construed broadly to include any greenhouse gas that can be considered to have a greenhouse effect and can be sequestrated by any suitable biological process. Thus, expressions such as “method for processing carbon dioxide” and “transaction of carbon dioxide” shall be interpreted to include equivalents. The term “carbon dioxide equivalent”, or “CO2eq”, may also be used with the same meaning in the context of the present disclosure. Consequently, “CO2 sequestration” may equivalently refer to sequestration of CO2, any greenhouse gas, or any equivalent thereof.

“CO2 sequestration”, within the context of the present disclosure, refers to a biological process, in which a greenhouse gas is sequestered via, for example, farming, agriculture, forestry etc. The present disclosure does not concern geological sequestration.

A distributed ledger is a consensus of replicated, shared, and synchronized digital data spread across a plurality of computing devices. When a farmer is able to sequestrate CO2 through biomass in the soil, the system can add a CO2 token. The CO2 token is assigned to a CO2 sequestration associated with a specific geographic area. Preferably, the CO2 token comprises a targeted quantity of CO2. The CO2 token may also comprise a specific financial compensation for the targeted quantity of CO2 for a specific geographic area. In practice this may have the meaning that a buyer will pay a producer for sequestrating an agreed quantity of CO2 in for a specific geographic area, for example, by cultivating a crop or plant. Crops and plants may comprise, for example crops and plants grown outside normal growing season, and/or cover crops, but may also be conventional crops, including food, feed, fuel, fiber, raw material, land restauration, forestry and aqua culture. The plant does not necessarily be crops that are economically viable to grow for, for example, food purposes. Crops may be grown in otherwise deserted areas. The invention is not limited to any particular type of crop or plant growing in the geographic area. The geographic area may be any area, including but not limited to, for example, fields, forests, deserted land, gardens, and roof gardens. The geographic area may also comprise areas of vertical farming, urban farming and restoration of land.

The carbon dioxide sequestration associated with a geographic area may correspond to a certain amount of sequestrated CO2. The carbon dioxide sequestration may be associated with the task of carrying out the action of growing a plant in the geographic area for a certain agreed period of time, which corresponds to sequestrating a certain amount of CO2.

The method further comprises obtaining at least a first image, such as a first satellite image, of the geographic area before the sequestration and at least a second image, such as a second satellite image, of the geographic area after the sequestration. The first and second images are used to determine whether the carbon dioxide sequestration has been effectuated. The step of determining whether the carbon dioxide sequestration has been effectuated may comprise an estimation, which may include a calculation, of the quantity of CO2 sequestered between the first and second satellite images. Moreover, more than two images may be used for the estimation. The geographic area may also be continuously monitored. Satellite imaging technology may be combined with a model of biomass change to estimate the sequestered quantity of CO2. The sequestered quantity of CO2 may be determined and calculated based on individual species' CO2 binding capacity and environmental conditions.

Once the quantity of CO2 has been sequestered, it can be determined whether the agreed carbon dioxide sequestration has been effectuated. If this is the case, the system may further automatically trigger a payment for the carbon dioxide token and update the transaction of carbon dioxide in the distributed blockchain ledger on the plurality of computing devices. The system can thereby be said to link a transaction both to a plurality of computing devices through a distributed blockchain ledger and to a physical satellite imaging based verification of the CO2 sequestration. According to one embodiment of the presently disclosed method and system, an estimation of a total quantity of sequestrated carbon dioxide based on satellite images of the geographic area, which exceeds a targeted quantity of carbon dioxide, automatically triggers the payment of the quantity of compensation. The payment may be made in the form of a non-fungible token against digital currencies, such as a crypto representation, such as cryptocurrency. The payment may be administrated by means of a smart contract. A smart contract is a computer program or transaction protocol which is intended to automatically execute, control or document an event.

The disclosure further relates to a blockchain and satellite imaging based system for carbon dioxide transactions, the system comprising:
a distributed blockchain ledger, wherein at least a portion of the distributed blockchain ledger is stored on a plurality of computing devices; and
a processing unit configured to carry out any embodiment of the presently disclosed method for processing carbon dioxide related transactions.

The disclosure further relates to computer program having instructions which, when executed by a computing device or computing system, cause the computing device or computing system to carry out the presently disclosed method for processing carbon dioxide related transactions.

### BRIEF DESCRIPTION OF DRAWINGS

The invention will in the following be described with reference to the accompanying drawings, which are exemplary and not limiting to the presently disclosed method and a system for processing carbon dioxide related transactions.

FIG. 1 shows a flow chart of an embodiment of a computer-implemented method for processing carbon dioxide related transactions;

FIG. 2 shows a schematic view of an embodiment of the presently disclosed blockchain and satellite imaging based system for carbon dioxide transactions;

FIG. 3 shows an example of biomass monitoring of a satellite image of a geographic area.

### DETAILED DESCRIPTION OF THE INVENTION

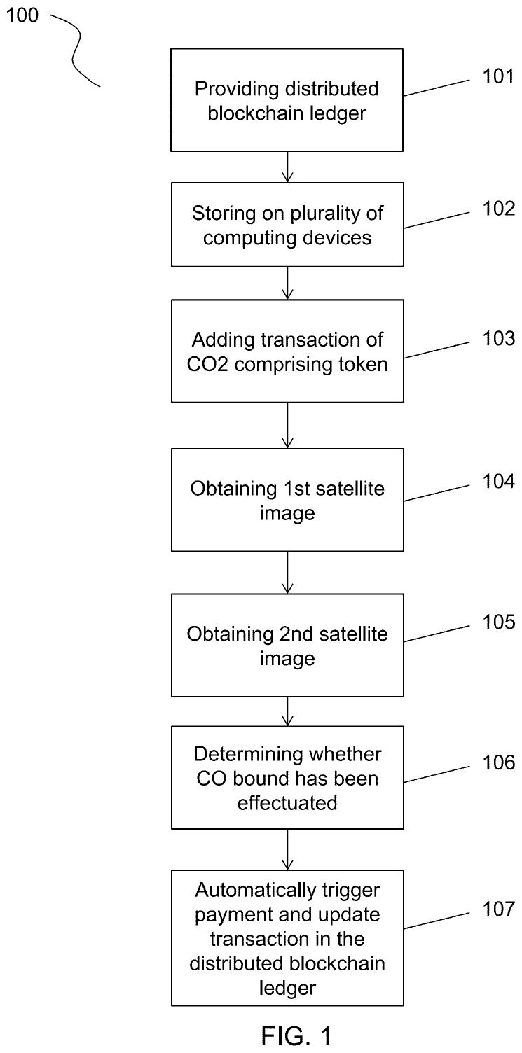

The present disclosure relates to a computer-implemented method for processing carbon dioxide related transactions. FIG. 1 shows a flow chart of a first embodiment of the computer-implemented method (100) for processing carbon dioxide related transactions. The method comprises the steps of:
providing (101) a distributed blockchain ledger;
storing (102) at least a portion of the distributed blockchain ledger on a plurality of computing devices;
adding (103) a transaction of carbon dioxide to the distributed blockchain ledger, wherein the transaction comprises a carbon dioxide token assigned to a carbon dioxide sequestration associated with a geographic area;
obtaining (104) at least a first satellite image of the geographic area at the time of the transaction;
obtaining (105) at least a second satellite image of the geographic area after the time of the transaction;
determining (106), based on the first satellite image and second satellite image whether the carbon dioxide sequestration has been effectuated; and
in case the carbon dioxide sequestration has been effectuated, automatically triggering (107) a payment for the carbon dioxide token and updating (107) the transaction of carbon dioxide in the distributed blockchain ledger on the plurality of computing devices. Each computing device may construct the transaction of carbon dioxide.

A distributed ledger is a consensus of replicated, shared, and synchronized digital data spread across a plurality of computing devices. A distributed ledger allows for transparent transactions. The distributed ledger database is spread across several devices on a peer-to-peer network, where each replicates and saves an identical copy of the ledger and updates itself independently. By storing data across its peer-to-peer network, the blockchain eliminates a number of risks that come with data being held centrally. The primary advantage is the lack of central authority. One form of distributed ledger design is the blockchain system. Blockchain technology is based on principles of cryptography, decentralization and consensus. Each block may contain a transaction or bundle of transactions. All transactions within the blocks are validated and agreed upon by a consensus mechanism, ensuring that each transaction is true and correct. A blockchain is a continuously growing list of records, called blocks, which are linked and secured using cryptography. Each block typically contains a hash pointer as a link to a previous block, a timestamp and transaction data. A transaction may comprise a monetary transaction but may also comprise other values and information. By design, blockchains are inherently resistant to modification of the data. A blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which needs a collusion of the network majority. “Storing at least a portion of the distributed blockchain ledger on a plurality of computing devices” in the context of the present disclosure has the meaning that the transaction of carbon dioxide, which is added to the distributed blockchain ledger, becomes distributed on a plurality of computing devices. The presently disclosed method and system may use any suitable blockchain technology.

A transaction within the context of the present application may comprise a carbon dioxide token assigned to a carbon dioxide sequestration associated with a geographic area be a transaction of a carbon credit. A defined targeted quantity of carbon dioxide is exchanged against a quantity of compensation. The compensation is typically a financial compensation, for example, expressed in a regular currency. It may, alternatively, be a compensation in a cryptocurrency or any other asset, such as fiat money, or another token. The quantity of carbon dioxide is typically provided in a unit, such as kilograms or tons. A token may be seen as a digital representation of an asset, in this case of a certain quantity of carbon dioxide sequestration. The token may be issued as a non-fungible token (NFT), as it refers to its capacity of not being exchanged in between them as of equal value. Accordingly, the presently disclosed method may comprise the step of creating a non-fungible token based on an estimated carbon dioxide sequestration between the first image and the second image. A token is, preferably, tradeable. The token may comprise a targeted quantity of carbon dioxide and a quantity of compensation for the targeted quantity of carbon dioxide. More specifically, the token may be associated with a CO2 sequestration associated with a specific geographic area. Preferably, the CO2 token comprises a targeted quantity of CO2. As plants grow they capture CO2 from the air. The presently disclosed method and system also works for algae in water, which can capture CO2 in the water. Consequently, biomass can be translated into captured CO2. The token of carbon dioxide may be associated with a buyer of the carbon dioxide sequestration and a producer of the carbon dioxide sequestration. Typically, the geographic area is property of a producer of the carbon dioxide sequestration. The producer may also be the seller of the carbon dioxide sequestration.

As stated above, the CO2 sequestration may be associated with a specific geographic area. Preferably, the geographic area can be cultivated to sequestrate the targeted quantity of carbon dioxide. The step of automatically triggering a payment for the carbon dioxide token and updating the transaction of carbon dioxide in the distributed blockchain ledger on the plurality of computing device in case the carbon dioxide sequestration has been effectuated can be seen as a link between a physical verification of the actual sequestered quantities of carbon and the integration into the distributed blockchain ledger.

According to one embodiment, the payment will be automatically triggered in a digital currency stored in a smart-contract. The user can, upon his/her own discretion convert to the desired fiat currency, or keep the cryptocurrency received in exchange for the CO2/CO2eq tokens.

The presently disclosed method uses imaging, such as satellite imaging, to determine whether the carbon dioxide sequestration has been effectuated. This will involve several image captured at different points in time. As a minimum, at least a first satellite image of the geographic area captured before the sequestration, and at least a second satellite image of the geographic area after an alleged sequestration will be used. The method will, based on the first satellite image and second satellite image determine whether the carbon dioxide sequestration has been effectuated. The method is not limited to capturing satellite images of the geographic area at two points in time. The method may capture satellite images continuously or with fixed intervals and continuously estimate how much carbon dioxide that has been sequestrated. The invention is not limited to satellite imaging. The images may be based on other imaging technologies, such as infrared imaging, ultraviolet imaging, radar images, spectral imaging, or LIDAR technology. The images may be captured by, for example, airborne or spaceborne vehicles. The imaging can also be used to assist the producer to assess and monitor the status of the farm, for example, via nutritional status, wet land, and soil structure,

Satellite observations can be used to estimate carbon dioxide sequestration. Depending on how accurate the estimation needs to be for a given carbon dioxide transactions, different technologies are possible. Examples of resolution include 30×30 cm and 10×10 m, which may be referred to as pixels. The resolution size may be selected such that some differences in the field is evened out. It may also be possible to analyse one or more specific pixel Generally, the estimation based on satellite imaging will benefit from calibration. As an example, it may be possible to use determined relationships between, for example, colors and shapes satellite images and biomass in the geographic area. The estimation of carbon dioxide sequestration may involve use of satellite observation tools and indexes, such as the Landsat Normalized Difference Vegetation Index (NDVI). With modern satellite technologies, this can be done at a relatively detailed level. Satellite images may in some cases be detailed enough to provide sizes of, for example, individual tree crown areas. The method may involve using a machine learning model trained to translate changes in time of satellite images to sequestrate carbon dioxide. The process of training such a model may be based on other technologies and real ground measurements. It is also possible to integrate detailed land cover information with ground observations of forest inventories. In one embodiment the method comprises the step of analyzing the satellite images using a machine learning model trained to translate changes in time of satellite images to sequestrated carbon dioxide. The machine learning model may be trained to translate changes in time of satellite images to sequestrated carbon dioxide for a specific geographic area.

The estimation of carbon dioxide sequestration may involve the calculation of biomass per area unit. The estimation of carbon dioxide sequestration may involve use of satellite observation tools and indexes, such as the Landsat Normalized Difference Vegetation Index (NDVI). NDVI can be calculated based on how much light that is reflected in a frequency near infrared and red light. The index may indicate an amount of living vegetation. Other equivalent or similar methods may be used. However, a part of a tree or plant may not be accounted for as chlorophyll. In such cases an assumption based on a model can be made to estimate the biomass. As an example, a tree stem may be estimated to have a mass 2-3 times greater than the mass of the crown. The figure typically depends on a number of parameters, such as species age etc. In this case, such a model can be used to estimate a total biomass, wherein the estimation is based on images and the model. Each plant type may associated with a factor. Based on an identification, or other information based on which the system is aware of the planet type in the area, the system can estimate the biomass and carbon dioxide sequestration. The method may comprise obtaining predetermined data about average biomass and dry weight per species. The method may further comprise above/below biomass ratio. As an example, 30-40% of the biomass may be in the root, whereas 60-70% may be above ground. This varies between species and may be accounted for.

The method may further comprise calculating species specific CO2 binding and may take into account above (e.g. canopy) and below ground (e.g. roots) biomass ratio and may take into account environmental impact, for example, natural or mediated CO2 impact over time.

The method may further comprise the step of distinguishing spectral reflectance patterns of different vegetation surfaces. Based on differences in vegetation for the satellite images at different points in time, the method may estimate a relatively rough sequestration.

The method may comprise the step of verifying that an actual quantity of carbon dioxide has been sequestrated by comparing at least the first satellite image and the second satellite image. This may include comparing specific details and colors in the images. It may also comprise the step of categorizing the land in the entire geographic area or parts of the geographic area.

The method may comprise the step of continuously, or by sampling, over a period of time, estimating a total quantity of sequestrated carbon dioxide based on satellite images of the geographic area. The total quantity of sequestrated carbon dioxide may be estimated for a period of time starting when the transaction of carbon dioxide is added. The estimation may include temporal and spatial monitoring. The estimation may also include crop type detection.

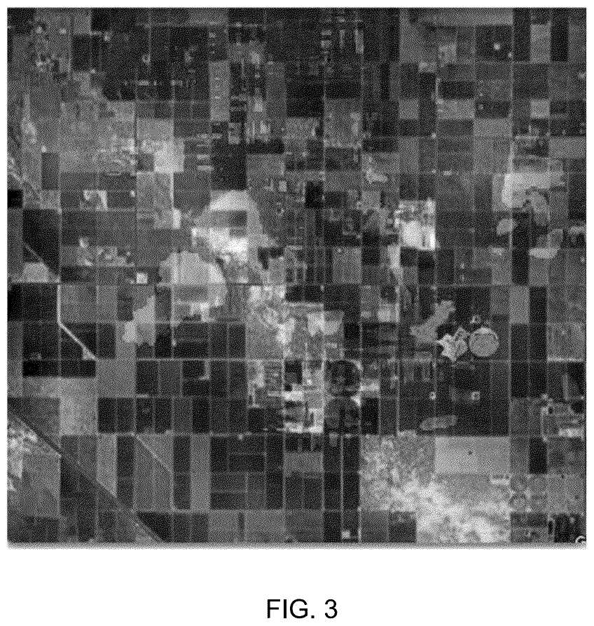

FIG. 3 shows an example of biomass monitoring of a satellite image of a geographic area. The image can be divided into sections having different weight, color or tone based on the level of biomass. Depending on how parts of, or the entire geographic area, develops after the transaction of carbon dioxide has been added to the distributed blockchain ledger, the presently disclosed method and system may determine whether the carbon dioxide sequestration has been effectuated.

The method may further comprise the step of performing one or more verifications of features related to the carbon dioxide transaction and/or carbon dioxide sequestration. In the event that certain features, such as authenticity of producers, geographic area, sequestration or payments, cannot be verified the system may send alerts, stop the process or perform addition control and verification.

The method may accordingly comprise the step of verifying the authenticity of the geographic area and/or the step of verifying an owner of the geographic area. This can be done in several ways. The method may comprise the step of matching name and owner data of the producer/seller with official name and owner data in official databases or registers. Alternatively, or in combination, the method may comprise the step of verifying the authenticity of the geographic area and/or the owner of the geographic area by obtaining confirmation by other nearby trusted producers. With multiple producers validating each other, the system, generally, becomes more secure. Alternatively, or in combination, other third party inspectors may validate the authenticity of the geographic area and/or the owner of the geographic area. The method may comprise further validations, including, but not limited to, satellite data validating that the land has not changed over time, including changes related to field size, deforestation and ownership. If this is the case, the system may request that a further validation is performed. Verification of the authenticity of the geographic area and/or the owner of the geographic area may be added to the to the distributed blockchain ledger.

Embodiments of the presently disclosed method and a system for processing carbon dioxide related transactions may comprise verifications related to the producer and/or the geographic area, including one or more of the following verifications:
satellite check of GPS coordinates of the geographic area;
satellite check GPS coordinates matched with land register (ownership of land), which is matched with the producer;
satellite check of the geographic area/GPS coordinates in the past and the boarders of the field (has the land changed in size or form indicating change in ownership of the land, deforestation, or non-sustainable land use e.g. next to lakes or water with the risk of erosion);
satellite check for assessing biomass per area unit over time; control of normal growing season for food and CO2 crops.

The payment may be administrated by means of a smart contract. A smart contract is a computer program or transaction protocol which is intended to automatically execute, control or document an event. A smart contract may be seen as programs stored on a blockchain that run when predetermined conditions are met. Smart contracts may comprise “if-then” statements written into code on a blockchain. The plurality of computing devices may execute a task when predetermined conditions have been met and verified, in the present disclosure when the carbon dioxide sequestration has been effectuated. The blockchain may then be updated when the transaction is completed.

The method may further comprise the step of calculating and verifying a size of the geographical area, or a type of plant based on the first and/or second image, or the step of verifying a growth rate of a given plant based on the first and/or second image. Verification of a size of a geographical area is a task that can, itself, be considered to be common knowledge. Verification of a type of plant may also be possible, depending on how detailed imaged that can be provided. As an example, trained models for recognizing plant species in an image of a plant exist. The method may further comprise the step of computing the vegetation density based on the obtained images. Alternatively, the vegetation density may be obtained either as an assumed vegetation density or based on local measurements. Biomass assessment may be made using satellite observation tools and indexes, such as the Landsat Normalized Difference Vegetation Index (NDVI). Based on a vegetation density it is possible to extract or compute biomass for the area. “Carbon dioxide sequestration” in the context of the present application may refer to sequestration of carbon. Carbon sequestration is the process of storing carbon in a carbon pool. Carbon dioxide is naturally captured from the atmosphere through biological, chemical, and physical processes. References to “carbon dioxide sequestration” mean that carbon dioxide is captured by plants growing in the geographic area. “Carbon dioxide sequestration” also means that there is a net carbon sequestration that can be calculated based on the relation between carbon dioxide and carbon. The carbon in the biomass is composted to soil organic carbon at the end of the vegetation period i.e. sequestered to the soil and thereby removed from the atmosphere. A growth rate may be determined by comparing, for example, plants in the a first image with plants in the second image.

Embodiments of the presently disclosed method and a system for processing carbon dioxide related transactions may comprise verifications related to the sequestration, including one or more of the following verifications:
for a given geographic area, calculate the actual area to match an area provided by the producer;
for a given geographic area, provide plant species to be grown under what conditions, and verify against actually grown plants in the geographic area;
for a given geographic area, calculate expected CO2 sequestration;
for a given geographic area, provide an expected growth period and an expected biomass tonnage;
for a given geographic area, provide a maximum estimated growth rate and sequestration rate and verify against a growth rate provided by the producer.

Embodiments of the presently disclosed method and a system for processing carbon dioxide related transactions may comprise verifications related to tokens, including a quality control that limiting features of a given token is not broken, for example, that an organic crops cannot generate more than a certain predefined or calculated amount of biomass per area unit. If the amount of biomass exceed the predefined or calculated amount of biomass, the method may indicate a break agreement. The method may further comprise random triggering of manual inspection of the geographic area.

The method may further comprise the step of verifying the producer of the carbon dioxide sequestration and/or a local gateway or any other network node used with the producer. In such a step, at least one third party producer may verify the geographic area of the producer of the carbon dioxide sequestration. As an example, three or more third party producers may verify that the producer of the carbon dioxide sequestration is the correct producer. In case Internet access is not available or works poorly for the producer of the carbon dioxide sequestration, a system may be implemented, for example a peer-to-peer network based on, for example, LoRaWAN IT, which implements gateways (hotspot) or any suitable network node. Such a system may include a “witness” system to verify network nodes, such as gateways, or producers or geographic areas. The authenticity of the network nodes or gateways can be verified by network nodes or gateway owners.

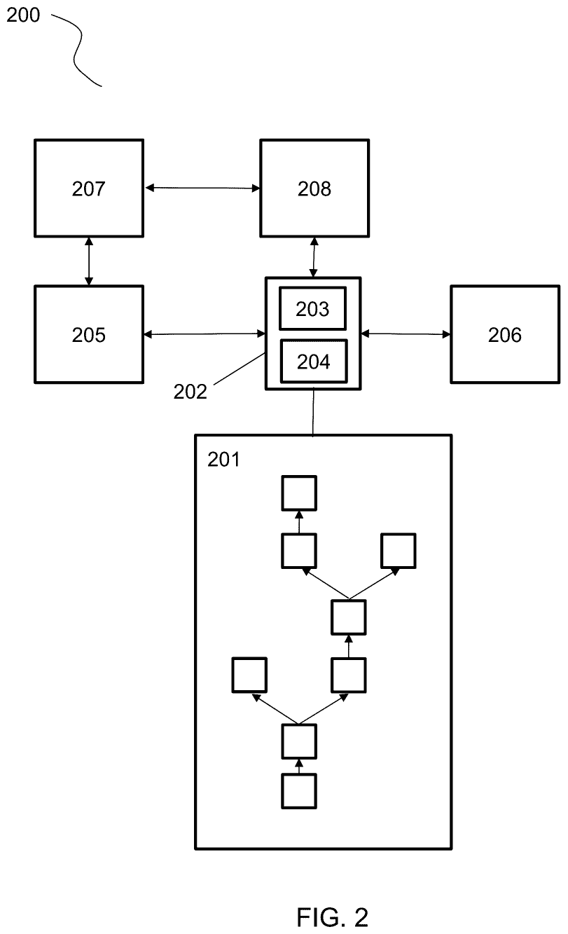

The present disclosure further relates to a blockchain and satellite imaging based system for carbon dioxide transactions. FIG. 2 shows an exemplary schematic view of an embodiment of the presently disclosed blockchain and satellite imaging based system (200) for carbon dioxide transactions. The system (200) comprises:
a. a distributed blockchain ledger (201), wherein at least a portion of the distributed blockchain ledger is stored on a plurality of computing devices (207);
b. a processing unit (208) configured to:
   i. add a transaction of carbon dioxide to the distributed blockchain ledger, wherein the transaction comprises a carbon dioxide token (202) assigned to a carbon dioxide sequestration (203) associated with a geographic area;
   ii. obtain at least a first satellite image of the geographic area at the time of the transaction;
   iii. obtain at least a second satellite image of the geographic area after the time of the transaction.

The token may comprise a targeted quantity of carbon dioxide (203) and a quantity of compensation (204), such as an amount of a currency.

The first and second satellite images may be obtained from any suitable imaging device (207).

The processing unit (208) may be further configured to
determine, based on the first satellite image and second satellite image whether the carbon dioxide sequestration has been effectuated; and
in case the carbon dioxide sequestration has been effectuated, automatically trigger a payment for the carbon dioxide token and update the transaction of carbon dioxide in the distributed blockchain ledger on the plurality of computing devices.

FIG. 2 further includes a producer (205), such as a farmer, and a buyer (206) of a carbon dioxide sequestration. The producer (205) and buyer (206) interact with the presently disclosed blockchain and satellite imaging based system for carbon dioxide transactions but are not part of the system.

As a person skilled in the art would understand, the processing unit of the system may be configured to carry out any embodiment of the presently disclosed method for processing carbon dioxide related transactions. The processing unit may be any type of processor device, for example, an type of special purpose or a general-purpose microprocessor device The processing unit may be a single processor or multiple processors The processing unit may be part of a cloud-based solution and/or operate in a cluster or server farm The system may further comprise a memory, for example, random access memory (RAM), and a secondary memory, such as a read-only memory (ROM). The system may further comprise the necessary communication interfaces

### Use Case and Further Examples

A producer of the carbon dioxide sequestration within the context of the present disclosure may be a farmer who wants to sell CO2 binding capacity of its land. The presently disclosed method and system may be implemented as a computer program that provides a front-end application in the form of a user interface. The system and method may be provided in a web-based provided on an Internet browser on, for example, a computer or mobile phone. The computer program may run on any suitable processing unit, including servers and cloud-based solutions and typically links relevant features, such as smart contracts, quality control assessments and transactions between the producer and a buyer.

The presently disclosed method and system may comprise a dashboard, which can be seen as an overview of data of one or more producers and associated geographic areas. The dashboard may allow the producer to geo-position its land coordinates and display the acreage of land. The method may, accordingly link satellite earth observations (SEO) and geo-positions of the given geo-positions given by the producer and automatically calculate an area. The information may then be added to the smart contract.

The producer may then enter a plant type, for example by selecting a crop in the dashboard. Preferably, the plant types are predefined plant types selected for their CO2 biomass binding capacity. The method or system can then calculate an expected CO2 sequestration. The method and system may the create a carbon dioxide sequestration associated with a geographic area, which is added to the smart contract.

In one embodiment, the producer then adds a time period for the crops to be grown. The method may automatically calculate a theoretical CO2 binding capacity of the total area and plants by combining the SEO land area and the crop biomass CO2 binding capacity of the land of the producer. The method may further reduce the CO2 binding capacity for negative CO2 binding activities, for example, tractor emissions for planting, and the use of blockchain.

In one embodiment the producer and buyer can visualize the actual field of biomass CO2 binding for an area via a satellite.

According to one example the total CO2 binding capacity per hectare is projected in the dashboard as X tons CO2. For a producer with Y hectares, the total CO2 binding capacity is shown by multiplying the land area from the SEO and the CO2 binding capacity X tons CO2. This generates the total tons of CO2 of the producers total land area. In addition, the time period selected by the producer may create a limit to which the producer is contractually committed.

The producer may enter a price, for example, 30 EUR/tons of CO2. The sales price may be added to the smart contract and also contractually binding.

The compensation for the CO2 sequestration may typically be financial compensation, for example, expressed in a regular currency or a cryptocurrency. In one embodiment both the producer and the buyer have a crypto wallet. The system and the method may control the executing of a transaction when the CO2 has been sequestrated. When a buyer accepts price and terms, the buyer may upload fiat money to its crypto wallet. The smart contract may automatically draw the money from the buyer's crypto wallet to become a “value representation”, which is placed on the blockchain. When the terms of the smart contract are fulfilled, the “value representation” may be moved to the producer's crypto wallet. From there the “value representation” can be converted to fiat currency. At the fulfillment of the smart contract, the system and method may
automatically push a CO2 binding certificate to the buyer with all data traceable to the specific producer, the land and quantity of CO2 offset. All data may be provided by the blockchain.

Satellite powered quality control may automatically collect, for example, satellite NDVI data of the producer's land. Based on satellite NDVI data the plant biomass growth i.e. the CO2 binding may be extracted or computed for the given time of the token. When the conditions of the smart contract are fulfilled, payments may be triggered. This can be done in steps of 25, 50 and 100% of the fulfilments.

1-20. (Canceled)

21. A computer-implemented method for processing carbon dioxide or carbon dioxide equivalent related transactions, the method comprising the steps of:
providing a distributed blockchain ledger;
storing at least a portion of the distributed blockchain ledger on a plurality of computing devices;
adding a transaction of carbon dioxide to the distributed blockchain ledger, wherein the transaction comprises a carbon dioxide token assigned to a carbon dioxide sequestration associated with a geographic area;
obtaining at least a first image, such as a first satellite image, of the geographic area captured before the sequestration;
obtaining at least a second image, such as a second satellite image, of the geographic area after the sequestration;
determining, based on the first image and second image whether the carbon dioxide sequestration has been effectuated; and
in case the carbon dioxide sequestration has been effectuated, automatically triggering a payment for the carbon dioxide token and updating the transaction of carbon dioxide in the distributed blockchain ledger on the plurality of computing devices.

22. The method according to claim 21, wherein the token of carbon dioxide comprises a targeted quantity of carbon dioxide and a quantity of compensation for the targeted quantity of carbon dioxide.

23. The method according to claim 21, wherein the geographic area can be cultivated to sequestrate the targeted quantity of carbon dioxide.

24. The method according to claim 21, wherein the token of carbon dioxide comprises a buyer of the carbon dioxide sequestration and a producer of the carbon dioxide sequestration.

25. The method according to claim 21, wherein the geographic area is property of a producer of the carbon dioxide sequestration.

26. The method according to claim 21, comprising the step of verifying that an actual quantity of carbon dioxide has been sequestrated by comparing at least the first image and the second image.

27. The method according to claim 21, comprising the step of continuously, or by sampling, over a period of time, estimating a total quantity of sequestrated carbon dioxide based on satellite images of the geographic area.

28. The method according to claim 27, wherein the total quantity of sequestrated carbon dioxide is estimated for a period of time starting when the transaction of carbon dioxide is added.

29. The method according to claim 21, comprising the step of analyzing the images using a machine learning model trained to translate changes in time of images to sequestrated carbon dioxide.

30. The method according to claim 29, wherein the machine learning model is trained to translate changes in time of images to sequestrated carbon dioxide for a specific geographic area.

31. The method according to claim 21, wherein an estimated total quantity of sequestrated carbon dioxide based on images of the geographic area, which exceeds a targeted quantity of carbon dioxide, automatically triggers the payment of the quantity of compensation.

32. The method according to claim 21, further comprising the step of verifying the authenticity of the geographic area.

33. The method according to claim 21, further comprising the step of verifying an owner of the geographic area.

34. The method according to claim 21, further comprising the step of calculating and verifying a size of the geographical area, or a type of plant based on the first and/or second image.

35. The method according to claim 21, further comprising the step of verifying a growth rate of a given plant based on the first and/or second image.

36. The method according to claim 21, further comprising the step of verifying the producer of the carbon dioxide sequestration and/or a local network node used with the producer.

37. The method according to claim 36, wherein the authenticity of the network node is verified by a network node owner.

38. A non-transitory storage medium comprising a computer program product having instructions embodied thereon, the computer program product, when executed by a computing device or system, causes the computing device or system to process carbon dioxide or carbon dioxide equivalent related transactions, by:
providing a distributed blockchain ledger;
storing at least a portion of the distributed blockchain ledger on a plurality of computing devices;
adding a transaction of carbon dioxide to the distributed blockchain ledger, wherein the transaction comprises a carbon dioxide token assigned to a carbon dioxide sequestration associated with a geographic area;
obtaining at least a first image, such as a first satellite image, of the geographic area captured before the sequestration;
obtaining at least a second image, such as a second satellite image, of the geographic area after the sequestration;
determining, based on the first image and second image whether the carbon dioxide sequestration has been effectuated; and
in case the carbon dioxide sequestration has been effectuated, automatically triggering a payment for the carbon dioxide token and updating the transaction of carbon dioxide in the distributed blockchain ledger on the plurality of computing devices.

39. A blockchain and imaging based system for carbon dioxide transactions, the system comprising:
a distributed blockchain ledger, wherein at least a portion of the distributed blockchain ledger is stored on a plurality of computing devices;
a processing unit configured to:
add a transaction of carbon dioxide to the distributed blockchain ledger, wherein the transaction comprises a carbon dioxide token assigned to a carbon dioxide sequestration associated with a geographic area;
obtain at least a first image, such as a first satellite image, of the geographic area before the sequestration;
obtain at least a second image, such as a second satellite image, of the geographic area after the sequestration;
determine, based on the first image and second image whether the carbon dioxide sequestration has been effectuated; and
in case the carbon dioxide sequestration has been effectuated, automatically trigger a payment for the carbon dioxide token and update the transaction of carbon dioxide in the distributed blockchain ledger on the plurality of computing devices.
